(19) United States
(12) Patent Application Publication
(10) Pub. No.: US 2012/0034491 A1
(43) Pub. Date: Feb. 9, 2012

(54) CMAS RESISTANT TBC COATING

(75) Inventor: Masamichi Hongoh, Manchester, CT (US)

(73) Assignee: UNITED TECHNOLOGIES CORPORATION, Hartford, CT (US)

(21) Appl. No.: 12/850,877

(22) Filed: Aug. 5, 2010

(51) Int. Cl. B32B 9/00; B05D 1/08; B05D 1/36

(52) U.S. Cl. 428/697; 427/402; 427/419.1; 427/446; 427/453; 428/702

(57) ABSTRACT

A process for forming a coating system on a turbine engine component comprises the steps of providing a substrate, depositing a thermal barrier coating on the substrate, depositing a reactive with known CMAS reaction kinetics on the thermal barrier coating, and activating the reactive layer prior to the component being placed in service. As a result of the foregoing process, there is provided a turbine engine component which has a substrate, a thermal barrier coating deposited on the substrate, a reactive layer deposited on the thermal barrier coating, which reactive layer has known CMAS reaction kinetics and is activated prior to the turbine engine component entering into service.

### BACKGROUND

The present disclosure is directed to a coating system for a turbine engine component which has an activated CMAS resistant reactive layer deposited over a thermal barrier coating and a method of forming same.

The durability and the maximum temperature capability of a thermal barrier coating (TBC) system used in gas turbine engines is often limited by deposits of calcium-alumino-silicate (CMAS). These deposits melt and wet the material, typically yttria-stabilized zirconia, used as the thermal barrier coating, causing it to be drawn by capillarity into all of the open void space. Upon cooling, when the CMAS solidifies, the penetrated layer develops a high modulus. Since the thermal barrier coatings rely on spatially configured voids to achieve strain tolerance with the superalloy substrate, those regions penetrated by the CMAS can be detrimental, causing the thermal barrier coating to be susceptible to extensive spallation when subjected to subsequent thermal cycles. Thermal barrier coating spallation can lead to a drastic reduction in the turbine engine component durability and to a direct attack on the underlying substrate.

A common approach to deal with this problem is to deposit an extra layer over the thermal barrier coating. However, this extra layer is not activated prior to the introduction of the component into service. As a result, it does not become activated until CMAS is encountered in service. CMAS comes with a variety of chemical compositions depending upon its geographical origin. Consequently, the effectiveness of this extra layer however is unknown and can be less than desirable.

### SUMMARY

In this disclosure, the CMAS risk is mitigated and the durability of a thermal barrier coating can be increased by creating an activated reactive layer with known CMAS reaction kinetics on thermal barrier coating, prior to service.

In accordance with the instant disclosure, there is described a process for forming a coating system on a turbine engine component which broadly comprises the steps of: providing a substrate; depositing a thermal barrier coating on the substrate; depositing a reactive with known CMAS reaction kinetics on the thermal barrier coating; and activating the reactive layer prior to the component being placed in service.

Further, in accordance with the present disclosure, there is provided a turbine engine component which broadly comprises a substrate; a thermal barrier coating deposited on the substrate; a reactive layer deposited on the thermal barrier coating, which reactive layer has known CMAS reaction kinetics and is activated prior to the turbine engine component entering into service.

Other details of the process and the turbine engine component are set forth in the following detailed description and the accompanying drawings, wherein like reference numerals depict like elements.

### BRIEF DESCRIPTION OF THE DRAWINGS

FIGS. 1 and 2 are schematic representations of a turbine engine component having a coating system with an outer CMAS reactive layer; and

FIGS. 3 and 4 are schematic representations of a turbine engine component having an alternative coating system with an outer CMAS reactive layer.

### DETAILED DESCRIPTION OF THE PREFERRED EMBODIMENT(S)

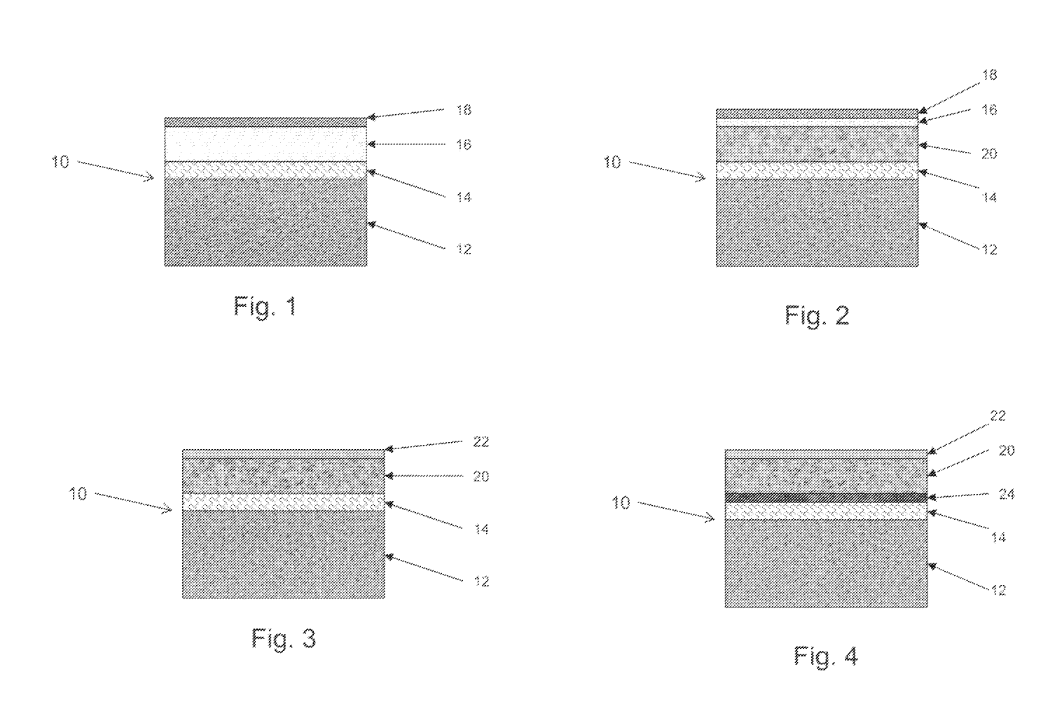

Referring now to FIGS. 1 and 2, there is shown a turbine engine component 10, such as a combustor panel or a turbine blade. The component 10 has a substrate 12 which may be formed from any suitable material known in the art, such as a ceramic composite material, a nickel based superalloy, a cobalt based alloy, or a titanium based alloy.

If desired, an optional bond coat 14 may be deposited on a surface of the substrate 12. The bond coat 14 may be deposited using any suitable technique known in the art and may comprise a material selected from the group consisting of aluminides, platinum alumindes, and MCrAlYs, where M is selected from the group consisting of nickel, cobalt, iron, and mixtures thereof.

Deposited on a surface of the bond coat 14, when the bond coat 14 is present, is a thermal barrier coating 16. If the bond coat 14 is not present, the thermal barrier coating 16 may be deposited directly on a surface of the substrate 12. The thermal barrier coating 16 may be formed from any suitable material known in the art. For example, the thermal barrier coating 16 can be a yttria stabilized zirconia deposited using an APS technique or EBPVD technique. The thermal barrier coating 16 may contain crystallization promoting elements, such as La₂Zr₂O₇, Gd₂Zr₂O₇, Al₂O₃, TiO₂, ZrO₂ and mixtures thereof. One suitable thermal barrier coating composition could be an APS deposited coating having a composition of (YSZ+A+B), where YSZ is yttria partially stabilized zirconia, and A and B are at least two of the crystallization promoting elements. Crystallization is a conversion of glass to fine-grained crystalline “glass-ceramics”.

If desired, a layer 20 may be deposited between the bond coat 14 and the layer 16. The layer 20 may be a conventional thermal barrier coating with YSZ or any suitable thermal barrier coating system.

Thereafter, an exterior CMAS resistant layer 18 may be deposited on the thermal barrier coating 16. The layer 18 may be a thin film of up to approximately 50 μm thick chemically conditioned CMAS material containing at least one reactive element, which can be selected from the group consisting of Gd₂Zr₂O₇ and TiO₂.

To create the CMAS layer 18, a powder mixture is prepared, having a nominal composition in Table 1.

TABLE 1
Nominal composition of the conditioned CMAS in mol. %

| | | | | | | |
|---|---|---|---|---|---|---|
| SiO₂ | CaO | MgO | Al₂O₃ | Na₂O | K₂O | Fe₂O₃ |

| | | | |
|---|---|---|---|
| 45 | 33 | 9 | 13 |

The chemical composition provides a powder mixture, which after thermo-chemical reaction with the thermal barrier coating layer 16, has a melting temperature significantly higher, at least 50 degrees Fahrenheit higher, than the melting temperature of the CMAS encountered in field engine applications.

The CMAS resistant layer 18 may be deposited using a solution-precursor plasma spray (SPPS) or a conventional APS procedure. The spray method of SPPS is identical to APS deposition with the substitution of a solution atomizer for the solid powder feeder. Plasma torch operating power and gas flow rates are in the same range as used for depositing APS coatings.

If desired, the top CMAS layer 18 may have graded characteristics from the interface with the thermal barrier coating 16 to the outer surface of the layer 18 for better adherence and strain compatibility.

After deposition, the deposited film of CMAS is subjected to a heat treatment at 2100° F.-2200° F. for up to 24 hours to form an active reaction layer. In this way, the CMAS layer is activated before the layer comes into contact with CMAS during service.

A reactive layer 18 formed as set forth hereinabove has CMAS reaction kinetics. The heat treatment turns the CMAS layer into CMAS glass, which reacts with the layer 16 underneath with nucleating agent, transitions to form globular anorthide phase, or to form a cubic garnet type crystal structure, depending upon the nucleating agents that are used.

The actively formed reaction layer 18 over the thermal barrier coating 16 has a melting temperature, which is significantly higher than the common CMAS encountered in the field. Upon contact with the common CMAS in a high temperature environment, the common CMAS with lower melting temperature will not readily dissolve into the reaction layer. Even if it dissolves into the reaction layer at higher temperature, it will recrystallize quickly within the reaction layer, which prohibits further CMAS penetration into the thermal barrier coating layer. Protecting the thermal barrier coating from spallation can significantly increase the durability of the turbine engine component 10 and thus save maintenance costs. The process described herein is simple and should be effective in protecting the turbine engine component by reducing and/or eliminating CMAS attacks.

Referring now to FIGS. 3 and 4, there is shown an alternative coating system deposited on the substrate 12. The coating system may have an optional bond coat 14, a thermal barrier coating 20 and an outer engineered CMAS layer 22 with at least one recrystallization agent discussed hereinbefore. As shown in FIG. 4, a layer 24 can be provided between the bond coat 14 and the thermal barrier coating 20. The layer 22 in each embodiment can be applied by APS or SPPS.

It is apparent that there has been provided in accordance with the instant disclosure a CMAS resistant TBC coating. While a specific embodiment of the coating has been described herein, other unforeseeable alternatives, variations, and modifications may become apparent to those skilled in the art having read the foregoing description. Accordingly, it is intended to embrace those alternatives, modifications, and variations which fall within the broad scope of the appended claims.

What is claimed is:

1. A process for forming a coating system on a turbine engine component which comprises the steps of:
providing a substrate;
depositing a thermal barrier coating on the substrate;
depositing a reactive layer with known CMAS reaction kinetics on the thermal barrier coating; and
activating the reactive layer prior to the component being placed in service.

2. The process of claim 1, wherein said substrate providing step comprises providing a combustor panel.

3. The process of claim 1, wherein said thermal barrier coating depositing step comprises depositing a thermal barrier coating formed from a yttria-stabilized zirconia.

4. The process of claim 1, wherein said thermal barrier coating depositing step comprises depositing a thermal barrier coating formed from a yttria stabilized zirconia having at least one crystallization promoting element selected from the group consisting of La₂Zr₂O₇, Gd₂Zr₂O₇, Al₂O₃, TiO₂, ZrO₂, and mixtures thereof.

5. The process of claim 1, further comprising depositing a bond coat on a surface of said substrate prior to depositing said thermal barrier coating.

6. The process of claim 1, wherein said reactive layer depositing step comprises solution-precursor plasma spraying a thin film of chemically conditioned CMAS over the thermal barrier coating.

7. The process of claim 1, further comprising preparing a powder mixture having a chemical composition having a melting temperature, which after thermo-chemical reaction with the thermal barrier coating, is higher than the melting temperature of the CMAS encountered in service and said spraying step comprising spraying said powder mixture onto said thermal barrier coating.

8. The process of claim 7, wherein said powder mixture preparing step comprises preparing a chemical composition wherein said melting temperature is at least 50 degrees Fahrenheit higher than the melting temperature of the CMAS encountered in service.

9. The process of claim 6, wherein said spraying step comprises spraying a thin film of chemically conditioned CMAS having a reactive element selected from the group consisting of Gd₂Zr₂O₇ and TiO₂.

10. The process of claim 6, wherein said activating step comprises subjecting said reactive layer to a heat treatment at a temperature in the range of 2100° F. to 2200° F.

11. A turbine engine component comprising:
a substrate;
a thermal barrier coating deposited on the substrate;
a reactive layer deposited on the thermal barrier coating; and
said reactive layer having known CMAS reaction kinetics and being activated prior to the turbine engine component entering into service.

12. The turbine engine component according to claim 11, wherein said component is a combustor panel.

13. The turbine engine component of claim 11, further comprising a bond coat between said substrate and said thermal barrier coating.

14. The turbine engine component of claim 11, wherein said thermal barrier coating is formed from a yttria stabilized zirconia.

15. The turbine engine component of claim 11, wherein said thermal barrier coating is formed from a yttria stabilized zirconia having at least one crystallization promoting element selected from the group consisting of La₂Zr₂O₇, Gd₂Zr₂O₇, Al₂O₃, TiO₂, ZrO₂, and mixtures thereof.

16. The turbine engine component according to claim 11, wherein said reactive layer has a chemical composition which includes at least one of Gd₂Zr₂O₇ and TiO₂.

17. The turbine engine component of claim 11, wherein said reactive layer has a melt temperature which is higher than the melt temperature of the CMAS encountered during service.

18. The turbine engine component of claim 17, wherein said melt temperature of the reactive layer is at least 50 degrees Fahrenheit higher than the melt temperature of the CMAS encountered during service.

19. The turbine engine component of claim 11, wherein said reactive layer has graded characteristics from an interface with said thermal barrier coating to an external surface of said reactive layer.
